(19) United States
(12) Patent Application Publication
(10) Pub. No.: US 2008/0000228 A1
(43) Pub. Date: Jan. 3, 2008

(54) System and method for exhaust recirculation

(75) Inventor: Andrew J. Kieser, Morton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/477,519

(22) Filed: Jun. 30, 2006

(51) Int. Cl. F01N 5/04; F01N 3/10; F02B 33/44

(52) U.S. Cl. 60/605.1; 60/612; 60/302; 60/280

(57) ABSTRACT

An engine assembly may include an engine having a plurality of combustion cylinders, and an exhaust manifold configured to receive exhaust from the plurality of combustion cylinders. The exhaust manifold may be divided into first and second sections. The first section may be fluidly coupled to a first group of combustion cylinders, and the second section may be fluidly coupled to a second group of combustion cylinders. The engine assembly may also include a turbocharger having an exhaust turbine configured to receive exhaust from the first section. The engine assembly may further include a proportional valve assembly configured to selectively fluidly couple the second section to at least one of the turbocharger and an exhaust recirculation loop.

### U.S. GOVERNMENT RIGHTS

This invention was made with government support under the terms of DE-FC05-00OR22806 awarded by the Department of Energy. The government may have certain rights in this invention.

### TECHNICAL FIELD

The present disclosure relates generally to a system for recirculating exhaust, and more particularly, to a turbocharged system for recirculating exhaust in an engine assembly.

### BACKGROUND

Engines, including diesel engines, gasoline engines, gaseous fuel-driven engines, and other engines known in the art, may exhaust a complex mixture of air pollutants. The air pollutants may be composed of gaseous and solid material, including particulate matter, nitrogen oxides (NOx), and sulfur compounds.

Due to heightened environmental concerns, exhaust emission standards have become increasingly stringent over the years. The amount of pollutants emitted from an engine may be regulated depending on the type, size, and/or class of engine. One method that has been implemented by engine manufacturers to comply with engine emissions regulations is exhaust recirculation. Exhaust recirculation systems may recirculate engine exhaust into an intake air supply and combustion cylinders of the engine. The exhaust may help to reduce the concentration of oxygen within the cylinders, thereby lowering the maximum combustion temperature within each of the cylinders. The lowered maximum combustion temperature and reduced oxygen concentration can slow the chemical reaction of the combustion process and reduce the formation of NOx. However, in an engine that also includes a turbocharger assembly powered by engine exhaust, the power supplied to the turbocharger assembly may decrease as exhaust is directed away from the turbocharger assembly and towards the intake air supply. Furthermore, energy, in the form of heat, may be lost as the engine exhaust travels towards the intake manifold.

At least one system has been developed for providing exhaust recirculation in an engine having a turbocharger assembly. For example, U.S. Patent Application Publication No. 2005/0103013 to Brookshire et al. (“Brookshire”) discloses an engine having an exhaust recirculation system and multiple turbochargers. Exhaust may be used to drive the turbines of the turbochargers before recirculating back to the engine. However, in Brookshire, all of the engine's cylinders may be subject to backpressure associated with the exhaust recirculation system. The backpressure may negatively affect the efficiency of the engine, and may result in reduced performance.

The disclosed system is directed to overcoming one or more of the problems set forth above.

### SUMMARY OF THE INVENTION

In one aspect, the presently disclosed embodiments may be directed to an engine assembly. The engine assembly may include an engine having a plurality of combustion cylinders, and an exhaust manifold configured to receive exhaust from the plurality of combustion cylinders. The exhaust manifold may be divided into first and second sections. The first section may be fluidly coupled to a first group of combustion cylinders, and the second section may be fluidly coupled to a second group of combustion cylinders. The engine assembly may also include a turbocharger having an exhaust turbine configured to receive exhaust from the first section. The engine assembly may further include a proportional valve assembly configured to selectively fluidly couple the second section to at least one of the turbocharger and an exhaust recirculation loop.

In another aspect, the presently disclosed embodiments may be directed to a machine. The machine may include an engine assembly including an engine having an intake manifold and a plurality of combustion cylinders fluidly coupled to the intake manifold. The machine may also include an exhaust assembly. The exhaust assembly may include an exhaust manifold divided into first and second sections. The first section may be fluidly coupled to a first half of the combustion cylinders, The second section may be fluidly coupled to a second half of the combustion cylinders. The exhaust assembly may also include a turbocharger assembly downstream from the exhaust manifold, and a proportional valve assembly between the exhaust manifold and the turbocharger assembly. The proportional valve assembly may be configured to selectively fluidly couple the second section to at least one of an exhaust loop and an exhaust recirculation loop of the exhaust assembly. The machine may also include an intake gas loop fluidly coupled to the exhaust recirculation loop and the intake manifold.

In yet another aspect, the presently disclosed embodiments may be directed to a method of managing intake gas in an engine assembly. The method may include dividing a plurality of combustion cylinders into first and second cylinder groups. The method may also include fluidly coupling the first cylinder group to a first section of an exhaust manifold, and fluidly coupling the second cylinder group to a second section of the exhaust manifold. The method may further include providing a proportional valve assembly downstream from the second section. The method may also include combusting fuel in the combustion cylinders, the combustion producing exhaust. The method may further include directing the exhaust into the first and second sections, and directing the exhaust from the second section into the proportional valve assembly. The method may also include using an electronic control module to sense engine conditions and adjust the proportional valve assembly based at least in part on the sensed engine conditions.

### BRIEF DESCRIPTION OF THE DRAWINGS

FIG. 1 is a schematic illustration of an engine assembly according to an exemplary disclosed embodiment of the present disclosure.

FIG. 2 is a schematic illustration of the engine assembly according to another exemplary disclosed embodiment of the present disclosure.

FIG. 3 is a schematic illustration of the engine assembly according to yet another exemplary disclosed embodiment of the present disclosure.

FIG. 4 is a schematic illustration of the engine assembly according to yet another exemplary disclosed embodiment of the present disclosure.

FIG. 5 is a schematic illustration of the engine assembly according to yet another exemplary disclosed embodiment of the present disclosure.

FIG. 6 is a schematic illustration of the engine assembly according to yet another exemplary disclosed embodiment of the present disclosure.

FIGS. 7A-7D are flow diagrams of a method for exhaust recirculation according to an exemplary disclosed embodiment of the present disclosure.

FIGS. 8A-8D are flow diagrams of a method for exhaust recirculation according to another exemplary disclosed embodiment of the present disclosure.

FIGS. 9A-9D are flow diagrams of a method for exhaust recirculation according to yet another exemplary disclosed embodiment of the present disclosure.

FIGS. 10A-10C are flow diagrams of a method for exhaust recirculation according to yet another exemplary disclosed embodiment of the present disclosure.

### DETAILED DESCRIPTION

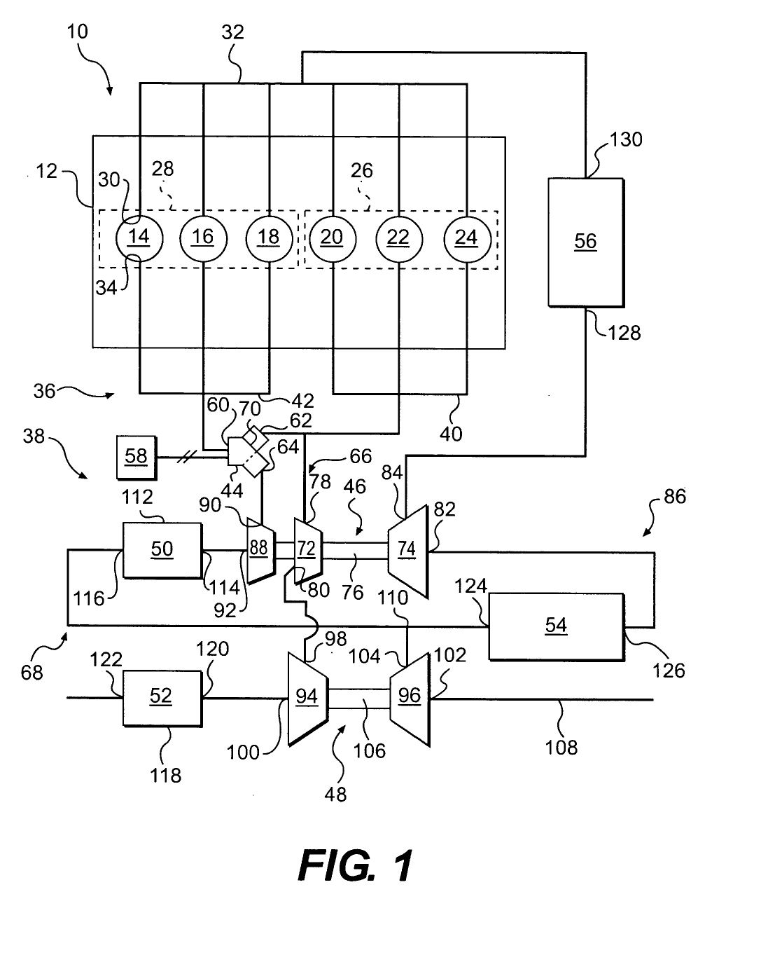

FIG. 1 illustrates an exemplary engine assembly 10 for a powered system or machine (not shown). Engine assembly 10 may include, among other things, a power source. In one embodiment, the power source may include an internal combustion engine 12, such as, for example, a diesel engine, a gasoline engine, a gaseous fuel-powered engine, and the like, or any other engine apparent to one skilled in the art.

Engine 12 may include combustion cylinders 14, 16, 18, 20, 22, and 24. Combustion cylinders 14, 16, 18, 20, 22, and 24 may be divided into a first cylinder group 26 and a second cylinder group 28. It should be understood that while six cylinders are shown in the drawings, engine 12 may include three, six, eight, ten, twelve, or any other suitable number of combustion cylinders. Each of cylinder groups 26 and 28 may include, for example, half of the total number of combustion cylinders 14, 16, 18, 20, 22, and 24. In the embodiment shown, combustion cylinders 20, 22, and 24 may belong to first cylinder group 26, while combustion cylinders 14, 16, and 18 may belong to second cylinder group 28.

Each of combustion cylinders 14, 16, 18, 20, 22, and 24 may be similarly structured, and it should be understood that the following description of combustion cylinder 14 may also apply to combustion cylinders 14, 16, 18, 20, 22, and 24. Combustion cylinder 14 may include an intake port 30 that may be selectively placed into fluid communication with an intake manifold 32 by opening and closing an intake valve assembly (not shown). Intake port 30 may be configured to permit entry of air, fuel, exhaust, and/or any suitable combination thereof from intake manifold 32 into combustion cylinder 14 when the intake valve assembly is open. The air, fuel, and/or exhaust may be compressed and combusted in combustion cylinder 14 using a piston assembly (not shown) and other components that would be apparent to one skilled in the art. Combustion cylinder 14 may also include an exhaust port 34, and an exhaust valve assembly (not shown) for selectively fluidly coupling exhaust port 34 and an exhaust manifold 36 of an exhaust assembly 38. Exhaust port 34 may allow exhaust and other byproducts to escape from combustion cylinder 14 after combustion of the air, fuel, and/or exhaust therein. It is also contemplated that combustion cylinder 14 may include a plurality of intake ports and/or exhaust ports to enhance performance.

Exhaust produced in combustion cylinders 14, 16, 18, 20, 22, and 24 may enter exhaust manifold 36 when their respective exhaust valve assemblies are open. In one exemplary embodiment, exhaust manifold 36 may be divided into a first section 40, fluidly coupled to combustion cylinders 20, 22, and 24 of first cylinder group 26, and a second section 42, fluidly coupled to combustion cylinders 14, 16, and 18 of second cylinder group 28.

As depicted in FIGS. 1-6, exhaust assembly 38 may include one or more turbochargers, diesel particulate filters, cooling devices, and/or flow conduits. Various exemplary embodiments of exhaust assembly 38 are described in greater detail below.

Referring again to FIG. 1, an exemplary embodiment of exhaust assembly 38 may include a valve assembly 44, a high pressure turbocharger 46, a low pressure turbocharger 48, an upstream diesel particulate filter 50, a downstream diesel particulate filter 52, an intercooler 54, an aftercooler 56, and a microprocessor based electronic control module 58.

Valve assembly 44 may include an inlet 60, a first outlet 62, a second outlet 64, and a gate 70. Gate 70 may be configured to move between a flow isolating position (shown as a solid line in FIGS. 1-5) and a flow coupling position (shown as a dashed line in FIGS. 1-5). When gate 70 is set in the flow isolating position, it may act as a barrier between inlet 60 and first outlet 62, effectively blocking the exhaust flow from second section 42 from entering an exhaust loop 66 of exhaust assembly 38 by directing the exhaust into an exhaust recirculation loop 68 of exhaust assembly 38. On the other hand, when gate 70 is set in the flow coupling position, it may fluidly connect inlet 60 and first outlet 62 while creating a barrier between inlet 60 and second outlet 64. With gate 70 in the flow coupling position, the exhaust from second section 42 may flow from inlet 60 to first outlet 62 and into exhaust loop 66.

Valve assembly 44 may include a proportional valve assembly, such that gate 70 may be selectively adjusted into its flow coupling and flow isolating positions, as well as into intermediate positions to provide control over the flow of exhaust between inlet 60 and first and second outlets 62 and 64. When gate 70 is moved into an intermediate position in between the flow coupling and flow isolating positions, exhaust entering inlet 60 from second section 42 may be divided into a first quantity that may flow towards first outlet 62 and exhaust loop 66, and a second quantity that may flow towards second outlet 64 and exhaust recirculation loop 68. Moving gate 70 closer to the flow isolating position may reduce the exhaust flow entering exhaust loop 66 from second section 42, while increasing the exhaust flow entering exhaust recirculation loop 68. The opposite may occur when gate 70 is moved closer to its flow coupling position.

Movement of gate 70 may be initiated by one or more control elements, including, for example, electronic control module 58. Through its relationship with valve assembly 44, electronic control module 58 may control the flow of recirculated exhaust within engine assembly 10.

High pressure turbocharger 46 may include a high pressure exhaust turbine 72 in exhaust loop 66, a high pressure compressor 74, and a shaft 76. High pressure exhaust turbine 72 may include an inlet 78 and an outlet 80. The exhaust flowing through exhaust loop 66 may enter inlet 78 and may flow across one or more turbine blades of a turbine wheel (not shown) to rotate the turbine wheel prior to exiting through outlet 80. High pressure exhaust turbine 72 may include a variable geometry turbine, a fixed geometry turbine, or any other suitable turbine as would be apparent to one skilled in the art.

High pressure compressor 74 may include an inlet 82, an outlet 84, and a compressor wheel (not shown), and may be fluidly coupled to an intake gas loop 86 of exhaust assembly 38. Shaft 76 may extend from the turbine wheel to the compressor wheel, and thus, rotation of the turbine wheel may cause rotation of shaft 76 and the compressor wheel. A fluid, such as air, exhaust, or a combination thereof, flowing into high pressure compressor 74 through inlet 82, may undergo compression from a low pressure to a higher pressure. The compressed fluid may exit from high pressure compressor 74 via outlet 84.

High pressure turbocharger 46 may also include an exhaust recirculation turbine 88 in exhaust recirculation loop 68. Exhaust recirculation turbine 88 may include an inlet 90, an outlet 92, and a turbine wheel (not shown). The exhaust flowing through an upstream portion of exhaust recirculation loop 68 may enter inlet 90, rotate the turbine wheel, and then exit through outlet 92. Exhaust recirculation turbine 88, like high pressure exhaust turbine 72, may be configured to rotate shaft 76 and high pressure compressor 74. Accordingly, exhaust recirculation turbine 88 may provide additional rotational energy to assist high pressure exhaust turbine 72 in driving high pressure compressor 74. By recapturing at least some of the energy in the exhaust in exhaust recirculation loop 68, exhaust recirculation turbine 88 may help to ensure that high pressure compressor 74 receives sufficient power even when valve assembly 44 diverts exhaust from second cylinder group 28 away from high pressure exhaust turbine 72.

Low pressure turbocharger 48 may include a low pressure exhaust turbine 94 in exhaust loop 66, a low pressure compressor 96 in intake gas loop 86, and a shaft 106. Low pressure exhaust turbine 94 may include an inlet 98 and an outlet 100. The exhaust flowing in exhaust loop 66 may enter inlet 98 and may flow across one or more turbine blades of a turbine wheel (not shown) to rotate the turbine wheel prior to exiting through outlet 100. Low pressure compressor 96 may also include an inlet 102, an outlet 104, and a compressor wheel (not shown). Shaft 106 may extend from the turbine wheel to the compressor wheel, and rotation of the turbine wheel may be transferred by rotation of shaft 106 to the compressor wheel to drive low pressure compressor 96. It is contemplated that low pressure exhaust turbine 94 may include a variable geometry turbine, a fixed geometry turbine, or any other suitable turbine as would be apparent to one skilled in the art. Further, low pressure exhaust turbine 94 and/or high pressure exhaust turbine 72 may be constructed using lightweight materials, including, for example, titanium aluminide, and/or any other suitable material.

High pressure and low pressure compressors 74 and 96 may be included in intake gas loop 86 of engine assembly 10. A flow of air may enter inlet 102 of low pressure compressor 96 through an air conduit 108 at the upstream end of intake gas loop 86, whereupon the air may be compressed. The compressed air may exit from low pressure compressor 96 via outlet 104. At a junction 110 between exhaust recirculation and intake gas loops 68 and 86, the air in intake gas loop 86 may mix with exhaust from exhaust recirculation loop 68 at a location that may be upstream from high pressure compressor 74. High and low pressure turbochargers 46 and 48 may be arranged in series with one another such that low pressure compressor 96 may provide a first stage of pressurization, and high pressure compressor 74 may provide a second stage of pressurization.

Exhaust assembly 38 may also include upstream and downstream diesel particulate filters 50 and 52 located in exhaust recirculation and exhaust loops 68 and 86, respectively. Upstream diesel particulate filter 50 may include a filter housing 112 having an inlet 114 and an outlet 116, and filter medium (not shown) through which exhaust may be passed. Exhaust from exhaust recirculation turbine 88 may flow into filter housing 112 via inlet 114. The filter medium in filter housing 112 may trap or otherwise remove particulate matter from the exhaust, allowing filtered exhaust to exit through outlet 116. By removing particulates from the exhaust, a reduction in the amount or degree of fouling of engine assembly components downstream from upstream diesel particulate filter 50 may be achieved.

Downstream diesel particulate filter 52 may also include a filter housing 118 having an inlet 120 and an outlet 122, and a filter medium (not shown) contained therein. Downstream diesel particulate filter 52 may receive exhaust flowing from low pressure exhaust turbine 94 of low pressure turbocharger 48. When the exhaust is filtered, it may undergo additional treatment or exit out of engine assembly 10. It is contemplated that the filter medium may include a wire mesh, a courderite filter, or any other suitable particulate removing filter medium as would be apparent to one skilled in the art.

Intercooler 54 may be provided in intake gas loop 86, and may include an inlet 124 and an outlet 126, and may be configured to cool a mixture of exhaust and air, herein referred to as intake gas, as it flows from inlet 124 to outlet 126. Within intercooler 54, intake gas may flow into one or more conduits (not shown), and ambient air may flow across the walls of those conduits. Heat in the intake gas may transfer into the walls of the conduits where it may be carried away by the ambient air flow. This process may cool the intake gas, and the cooled intake gas may exit intercooler 54 through outlet 126. The cooled intake gas may be directed along intake gas loop 86 into high pressure compressor 74, where it may undergo compression. Additionally or alternatively, cooling may be carried out using engine jacket water coolant as a cooling medium. Further, the cooling medium may include a separate circuit cooling system (not shown) circulating water to cool the intake gas.

Aftercooler 56 may include an inlet 128, an outlet 130, and other components similar to those discussed above with respect to intercooler 54. Like intercooler 54, aftercooler 56 may also serve the purpose of cooling the intake gas. It is contemplated that in terms of structure, aftercooler 56 and intercooler 54 may be substantially identical, or may differ in size, shape, construction, and/or any other characteristic, depending upon the application in which exhaust assembly 38 may be employed.

Operation of engine assembly 10 may be at least partially controlled by electronic control module 58, which may be configured to monitor a variety of input signals and generate output signals based thereon to control the elements of engine assembly 10. Electronic control module 58 may also be configured to receive signals from one or more sensors (not shown) located on engine 12, valve assembly 44, upstream and downstream diesel particulate filters 50 and 52, high pressure and low pressure turbochargers 46 and 48, intercooler 54, and/or aftercooler 56. Electronic control module 58 may utilize the sensed information to calculate various engine-operating parameters to provide output signals, including operational instructions to components of engine assembly 10. For example, electronic control module 58 may control the movement of gate 70 of valve assembly 44 to regulate the flow of exhaust within engine assembly 10.

Accordingly, at least part of the flow of exhaust from combustion cylinders 14, 16, and 18 of second group 28 may be recirculated, via exhaust recirculation loop 68, into intake manifold 32 and combustion cylinders 14, 16, 18, 20, 22, and 24. However, the elements of exhaust recirculation loop 68, including, for example, valve assembly 44, exhaust recirculation turbine 88, and upstream diesel particulate filter 50, may act as flow restrictors, thus increasing the backpressure in exhaust recirculation loop 68. The efficiency of engine 12 may decrease with increasing backpressure because additional power may be required to push exhaust into exhaust assembly 38. Valve assembly 44 may isolate exhaust recirculation loop 68 from combustion cylinders 20, 22, and 24, and in doing so, the backpressure in recirculated exhaust loop 68 may only penalize combustion cylinders 14, 16, and 18 of second group 28, and not first group 26. Valve assembly 44 may serve a similar purpose in other embodiments of exhaust assembly 38 described below.

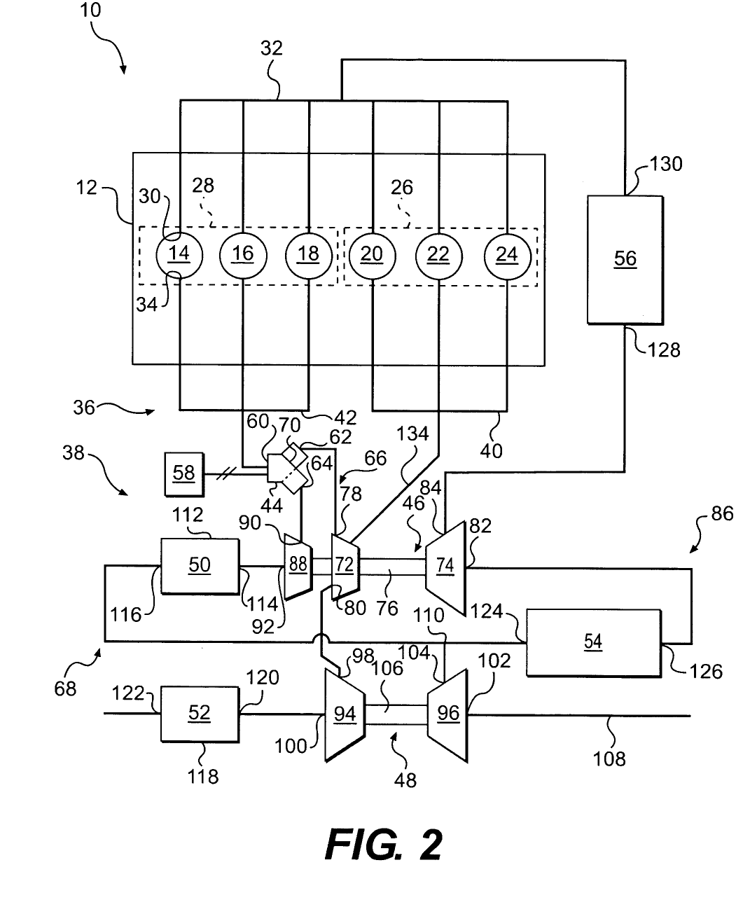

FIG. 2 shows another embodiment of exhaust assembly 38, where an upstream portion of exhaust loop 66 may include separate flow conduits 132 and 134 to direct the exhaust from first and second sections 40 and 42 into high pressure exhaust turbine 72 separately. This arrangement may help prevent backpressure from either of first and second groups 26 and 28 from negatively affecting the performance of the other group.

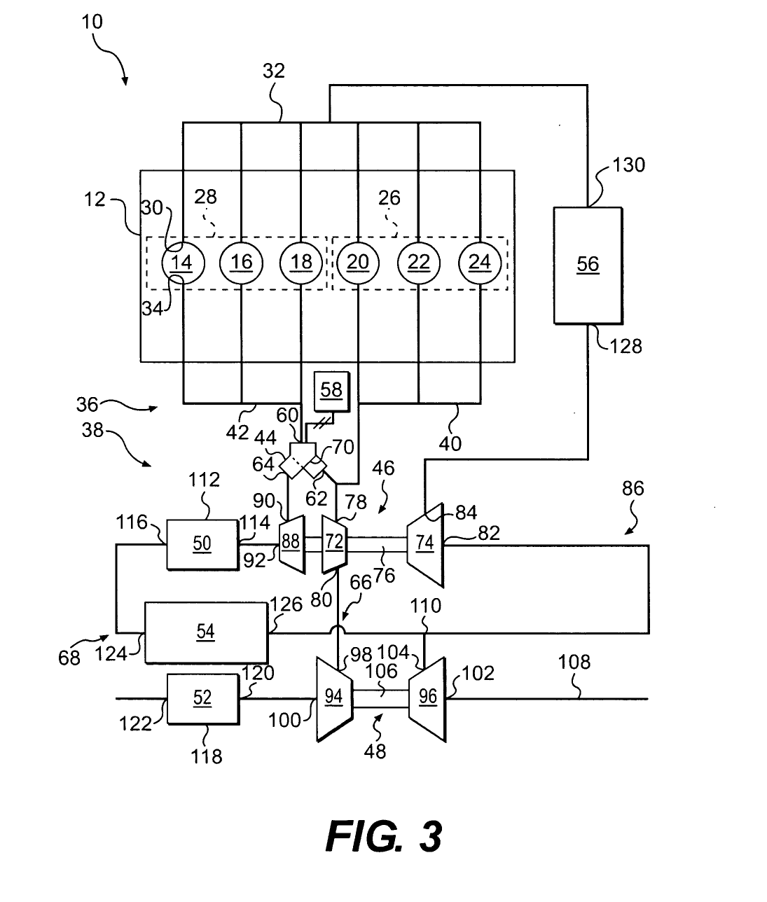

FIG. 3 illustrates yet another embodiment of exhaust assembly 38, wherein high pressure exhaust and exhaust recirculation turbines 72 and 88 may be mounted in opposite directions on shaft 76. This back-to-back arrangement may allow high pressure exhaust and exhaust recirculation turbines 72 and 88 to occupy less space than similarly sized turbines that may face in the same direction. It should be understood that this back-to-back arrangement may also be used in the previous embodiments of exhaust assembly 38. Also in this embodiment, intercooler 54 may be located in exhaust recirculation loop 68. This may help to reduce the number of performance reducing flow restrictions between high pressure and low pressure compressors 74 and 96.

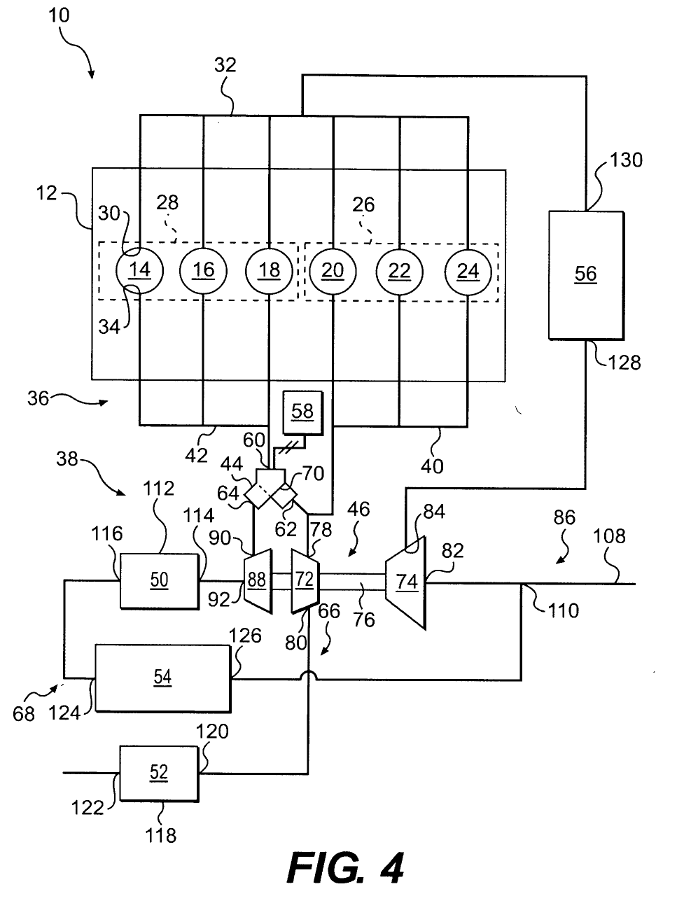

Yet another embodiment of exhaust assembly 38 is illustrated in FIG. 4. In this embodiment, high pressure turbocharger 46 alone may compress the intake gas. Using a single turbocharger for compression, rather than series turbochargers for performing multi-stage compression, may be adequate for certain tasks or machines. Additionally or alternatively, reducing the number of turbochargers in an engine assembly may be particularly desirable due to cost savings that may be achieved through reducing the number of components.

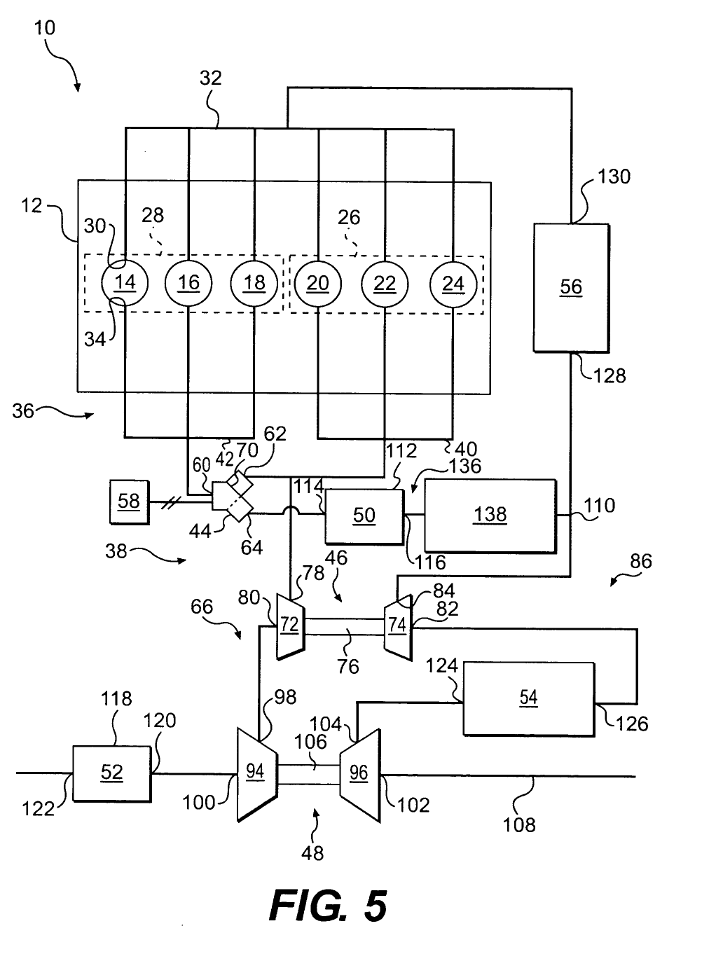

Yet another embodiment of exhaust assembly 38 is shown in FIG. 5. In this embodiment, high pressure turbocharger 46 may include a single turbine (high pressure exhaust turbine 72). Second outlet 64 of valve assembly 44 may be fluidly coupled to a high pressure exhaust recirculation loop 136. While passing through high pressure exhaust recirculation loop 136, the exhaust may be filtered by upstream diesel particulate filter 50 and cooled by a recirculated exhaust cooler 138 prior to mixing with air within intake gas loop 86. In this embodiment, electronic control module 58 may prevent the recirculation of exhaust into intake manifold 32 by moving gate 70 into the flow coupling position. Electronic control module 58 may also move gate 70 to the flow isolating position to provide intake manifold 32 with a flow of intake gas that may have a concentration of up to fifty percent exhaust.

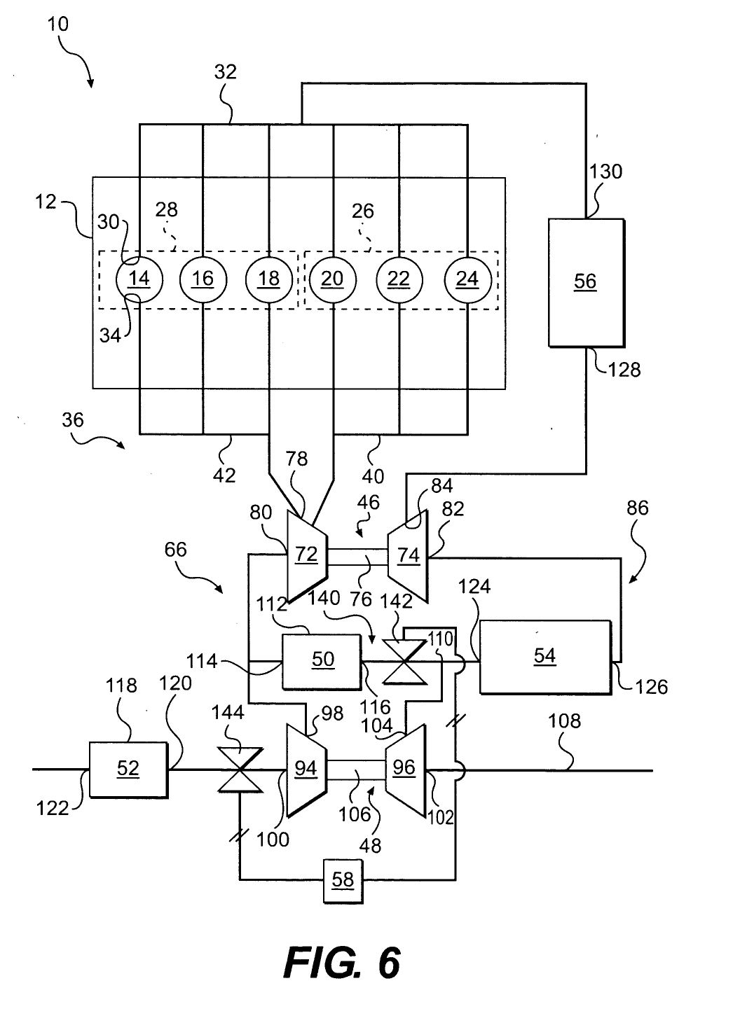

FIG. 6 illustrates yet another embodiment of exhaust assembly 38. In this embodiment, first section 40 may fluidly communicate with high pressure exhaust turbine 72. Second section 42 may also fluidly communicate with high pressure exhaust turbine 72. The exhaust entering high pressure exhaust turbine 72 may drive, via shaft 76, high pressure compressor 74. The exhaust may flow through exhaust loop 66 into low pressure exhaust turbine 94 of low pressure turbocharger 48, to drive low pressure compressor 96, prior to passing through downstream diesel particulate filter 52. A medium pressure exhaust recirculation loop 140 may be provided that may be fluidly coupled to exhaust loop 66 at a point between high pressure and low pressure turbochargers 46 and 48. Exhaust flowing through exhaust loop 66 may be selectively diverted into medium pressure exhaust recirculation loop 140 where it may be filtered by upstream diesel particulate filter 50. The filtered exhaust may flow towards junction 110, where medium pressure exhaust recirculation loop 140 may join with intake gas loop 86. Air from air conduit 108 in intake gas loop 86 may enter inlet 102 of low pressure compressor 96, where it may undergo compression prior to exiting from outlet 104. The compressed air may mix with the exhaust from medium pressure exhaust recirculation loop 140 at junction 110, and the mixture may continue along intake gas loop 86 in the direction of intake manifold 32.

An exhaust recirculation valve device 142 may be placed in medium pressure exhaust recirculation loop 140, and an exit valve device 144 may be placed in exhaust loop 66 at a downstream portion thereof. When exhaust recirculation valve device 142 is adjusted towards its closed position, it may restrict the flow of exhaust into medium pressure exhaust recirculation loop 140, and thus, may direct a quantity of the exhaust flow into the downstream portion of exhaust loop 66. In its completely closed position, exhaust recirculation valve device 142 may prohibit the flow of exhaust from entering medium pressure exhaust recirculation loop 140, and thus, the full flow of exhaust may remain in exhaust loop 66. Exit valve device 144 may be adjusted towards its closed position to divert the exhaust away from the downstream portion of exhaust loop 66, which may cause an increase in the quantity of exhaust flow entering medium pressure exhaust recirculation loop 140. In its completely closed position, exit valve device 144 may force the entire flow of exhaust through medium pressure exhaust recirculation loop 140.

Opening exhaust recirculation valve device 142 and/or closing exit valve device 144 may serve to decrease the quantity of exhaust flow entering low pressure exhaust turbine 94, while increasing the quantity of exhaust flow entering medium pressure exhaust recirculation loop 140. In doing so, low pressure compressor 96 may receive less power, and the amount of boost provided by low pressure compressor 96 may decrease accordingly. As the boost provided by low pressure compressor 96 decreases, the pressure at junction 110 between medium pressure exhaust recirculation loop 140 and intake gas loop 86 may also decrease. The decrease in pressure at junction 110 may reduce the backpressure on high pressure exhaust turbine 72 and on combustion cylinders 14, 16, 18, 20, 22, and 24. The reduction in backpressure may also allow for an increase in the flow of exhaust entering medium pressure exhaust recirculation loop 140.

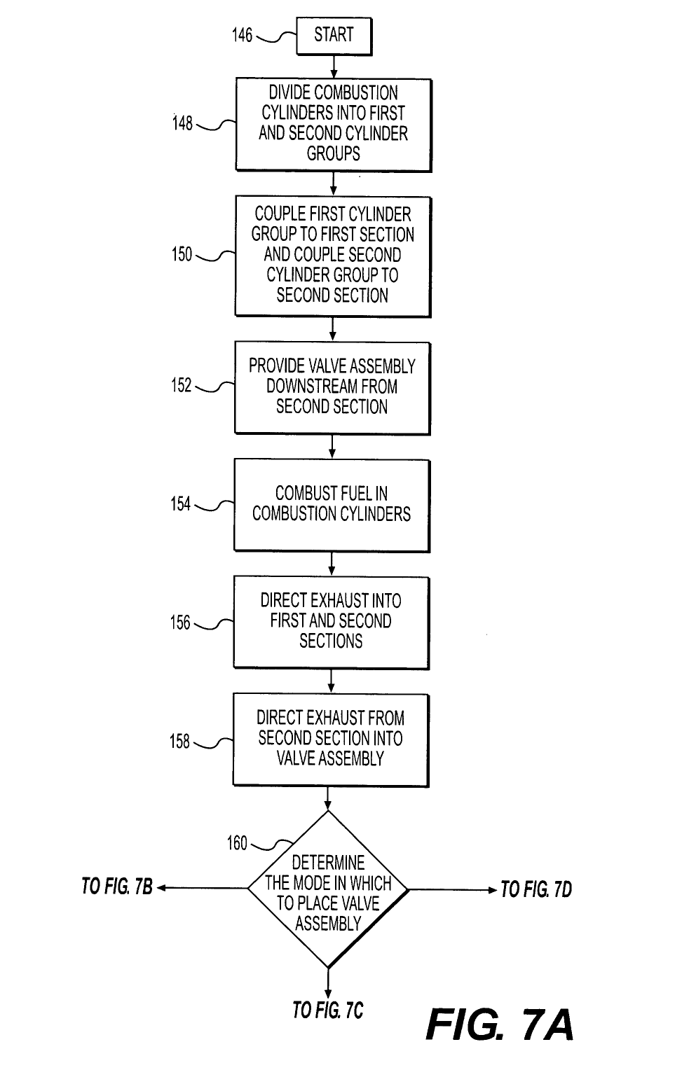

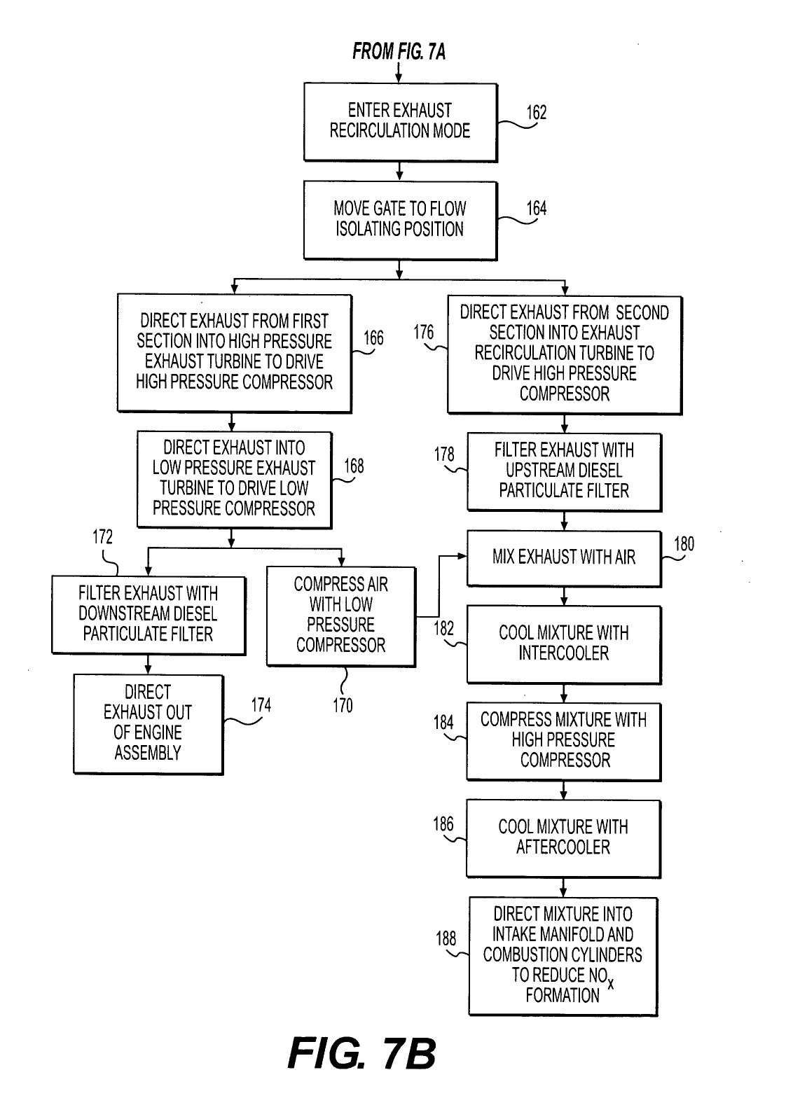

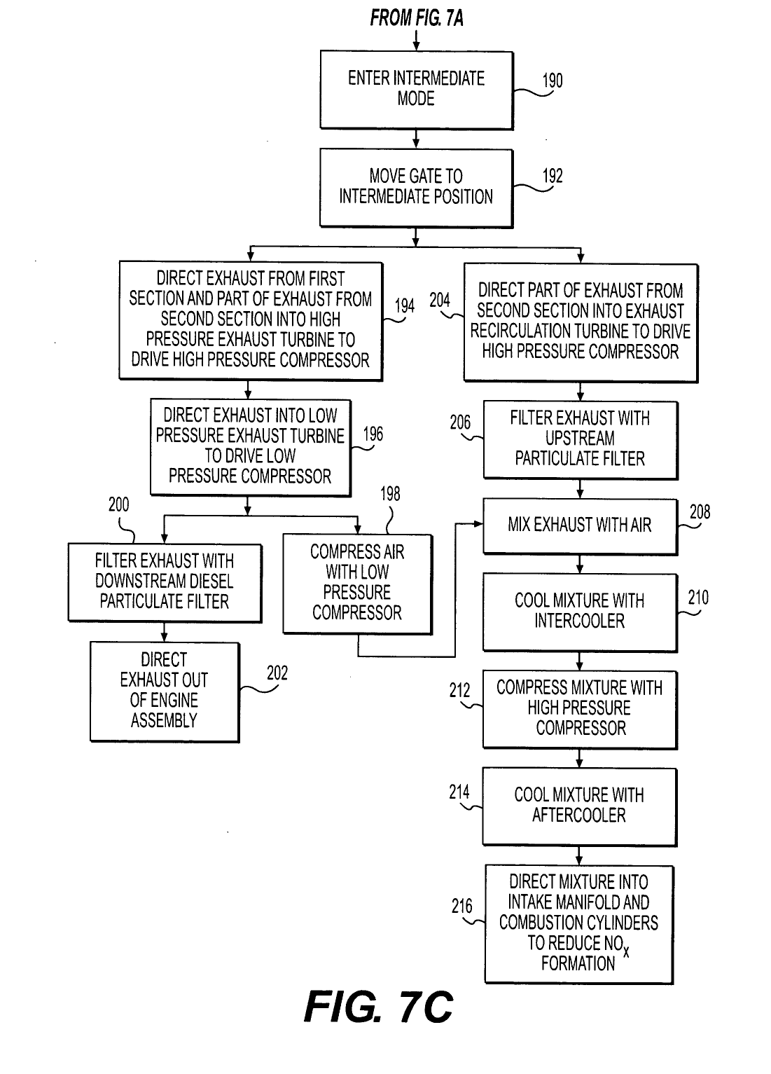

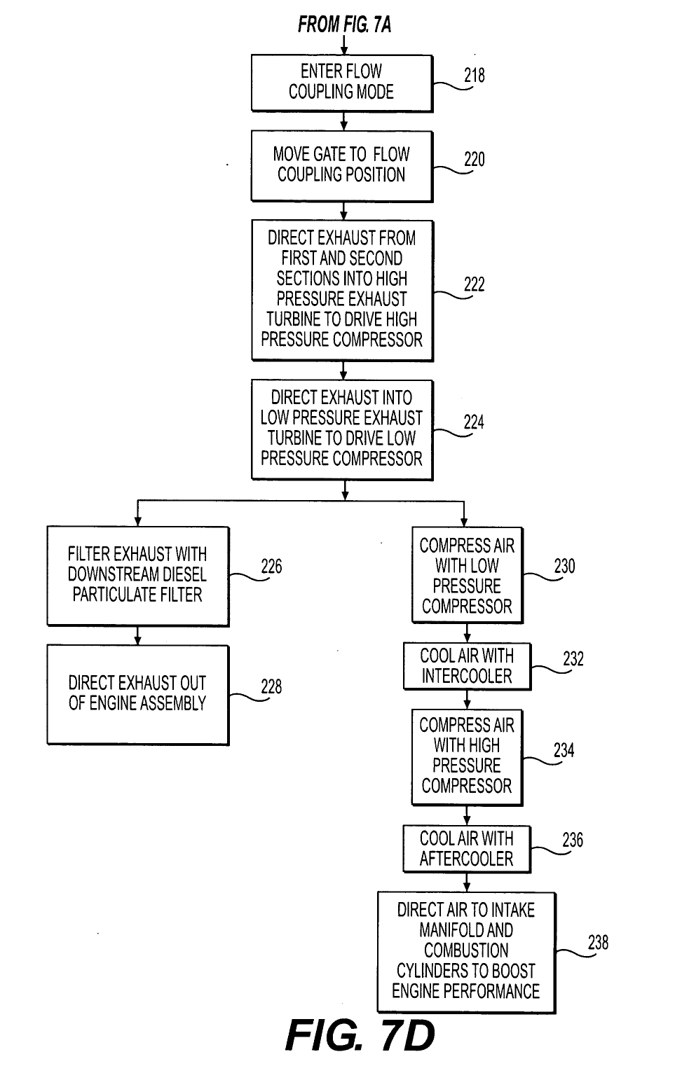

As shown in FIG. 7A, a method for exhaust recirculation may begin (step 146) with dividing combustion cylinders 14, 16, 18, 20, 22, and 24 into first and second cylinder groups 26 and 28 (step 148). First cylinder group 26 may be coupled to first section 40 of exhaust manifold 36 and second cylinder group 28 may be coupled to second section 42 of exhaust manifold 36 (step 150). A valve assembly 44 may be provided downstream from second section 42 (step 152). When fuel, air, and/or exhaust undergoes combustion in combustion cylinders 14, 16, 18, 20, 22, and 24 (step 154), the exhaust produced by combustion cylinders 14, 16, 18, 20, 22, and 24 may be directed into first and second sections 40 and 42 (step 156). The exhaust from second section 42 may be directed into valve assembly 44 (step 158). Electronic control module 58 may determine whether to place valve assembly 44 in an exhaust recirculation mode, an intermediate mode, or a flow coupling mode, based at least in part on the sensed engine conditions (step 160).

As shown in FIG. 7B, when valve assembly 44 is set in the exhaust recirculation mode (step 162), gate 70 may be moved to the flow isolating position (step 164) The exhaust from first section 40 may be directed into high pressure exhaust turbine 72 to drive high pressure compressor 74 (step 166). The exhaust may then be directed into low pressure exhaust turbine 94 to drive low pressure compressor 96 (step 168), which may compress air (step 170). The exhaust may be filtered using downstream diesel particulate filter 52 (step 172) before being directed out of engine assembly 10 (step 174). The exhaust from second section 42 may be directed into exhaust recirculation turbine 88 to drive high pressure compressor (step 176). The exhaust may be filtered (step 178), and then may be mixed with air compressed by low pressure compressor 96 to form a mixture having up to a fifty percent concentration of exhaust (step 180). The mixture may be cooled by intercooler 54 (step 182) prior to being compressed by high pressure compressor 74 (step 184). The mixture may also be cooled by aftercooler 56 (step 186). The mixture may enter intake manifold 32 and combustion cylinders 14, 16, 18, 20, 22, and 24 to reduce NOₓ formation in combustion cylinders 14, 16, 18, 20, 22, and 24 (step 188). It should be understood that at this point, the process may return to step 154.

As shown in FIG. 7C, when valve assembly 44 enters the intermediate mode (step 190), gate 70 may be moved to an intermediate position in between the flow isolating position and flow coupling positions (step 192). The exhaust from first section and part of the exhaust flow from second section 42 may be directed into high pressure exhaust turbine 72 to drive high pressure compressor 74 (step 194). The exhaust may be directed into low pressure exhaust turbine 94 to drive low pressure compressor 96 (step 196), which may compress air (step 198). Then, the exhaust may be filtered using downstream diesel particulate filter 52 (step 200) and directed out of engine assembly 10 (step 202). Another part of the exhaust flow from second section 42 may be directed into exhaust recirculation turbine 88 to help drive high pressure compressor 74 (step 204). The exhaust may be filtered by upstream particulate filter (step 206) and mixed with air compressed by low pressure compressor 96 (step 208). The mixture may be cooled by intercooler 54 (step 210) prior to being compressed by high pressure compressor 74 (step 212). The mixture may also be cooled by aftercooler 56 (step 214). The mixture may then be supplied to intake manifold 32 and combustion cylinders 14, 16, 18, 20, 22, and 24 to inhibit the formation of NOₓ therein (step 216). Here, the process may return to step 154.

As shown in FIG. 7D, when valve assembly 44 enters the flow coupling mode (step 218), gate 70 may be moved to the flow coupling position (step 220). As such, all of the exhaust flow from first and second sections 40 and 42 may be directed into high pressure exhaust turbine 72 to drive high pressure compressor 74 (step 222). After exiting from high pressure exhaust turbine 72, the exhaust may be directed into low pressure exhaust turbine 94 to drive low pressure compressor 96 (step 224) prior to being filtered (step 226) and directed out of engine assembly 10 (step 228). The air compressed by low pressure compressor 96 (step 230) may be cooled by intercooler 54 (step 232) prior to being compressed by high pressure compressor 74 (step 234). The air may be cooled by aftercooler 56 (step 236). The air may then be supplied to intake manifold 32 and combustion cylinders 14, 16, 18, 20, 22, and 24 to help boost engine performance (step 238). Here the process may return to step 154.

It is contemplated that the exhaust recirculation mode may be particularly useful for quickly reducing NOₓ in combustion cylinders 14, 16, 18, 20, 22, and 24. During operation of engine 12, electronic control module 58 may move valve assembly 44 into the exhaust recirculation mode upon sensing that the concentration of NOₓ in the exhaust flow being expelled from engine 12 is in a critical range. The intermediate mode may be used during steady state operation of engine 12. During steady state operation, electronic control module 58 may adjust the ratio of exhaust to clean air in the mixture of intake gas that may be supplied to combustion cylinders 14, 16, 18, 20, 22, and 24. The adjustment may help to create a suitable balance between engine performance and NOₓ reduction. The flow coupling mode may be helpful when engine response is important, such as, for example, during engine acceleration, to help ensure that air flow to combustion cylinders 14, 16, 18, 20, 22, and 24 is sufficient.

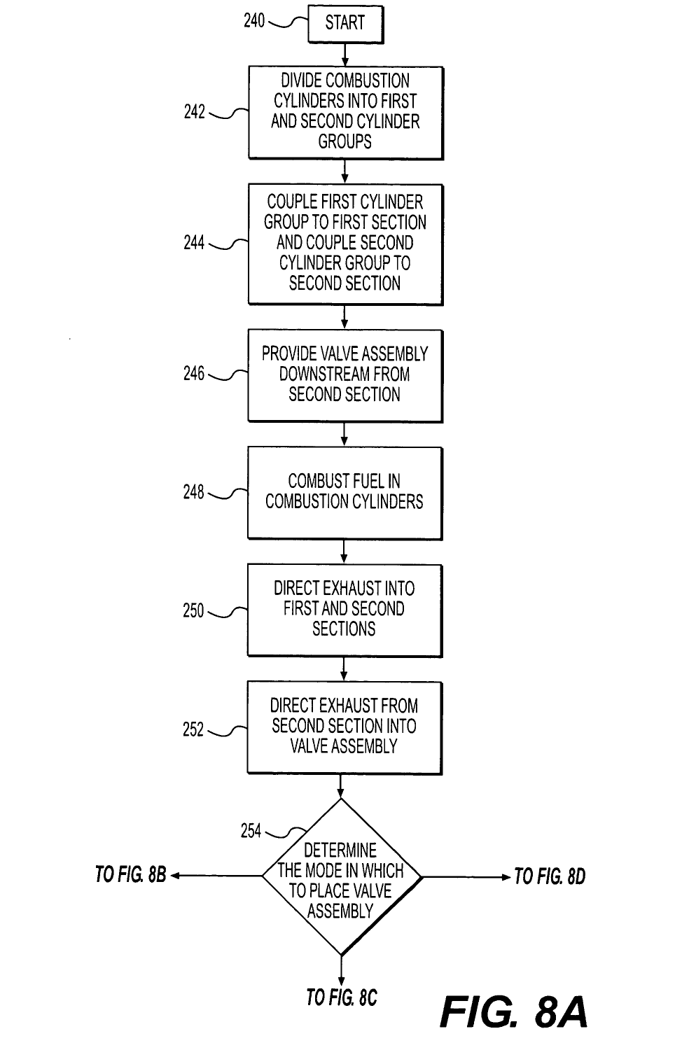

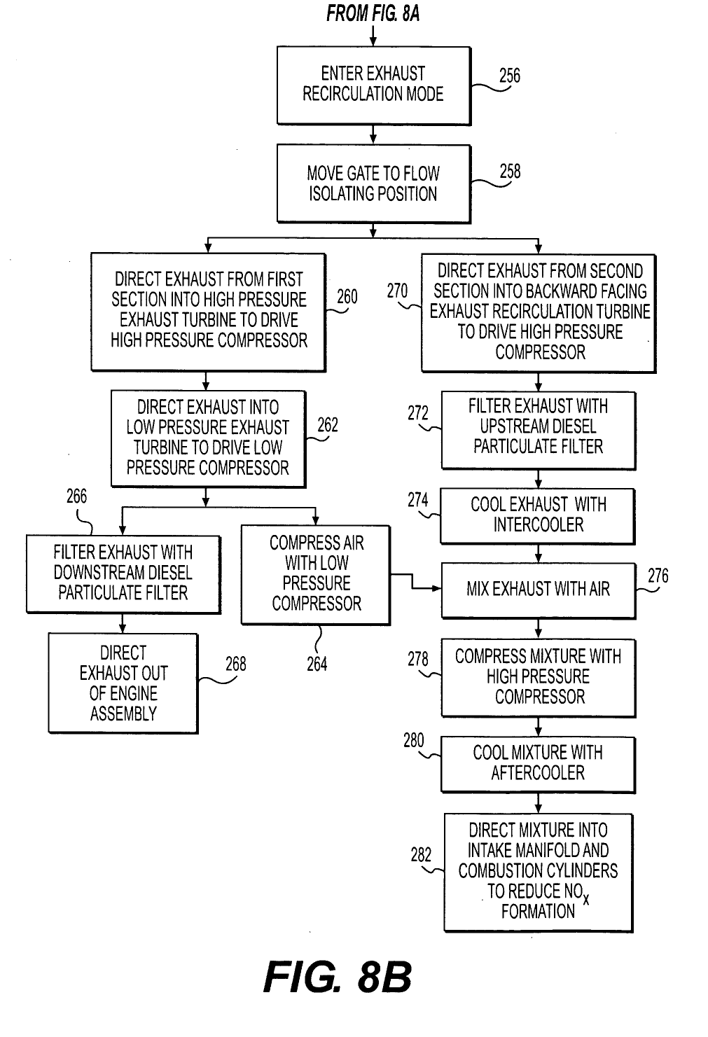

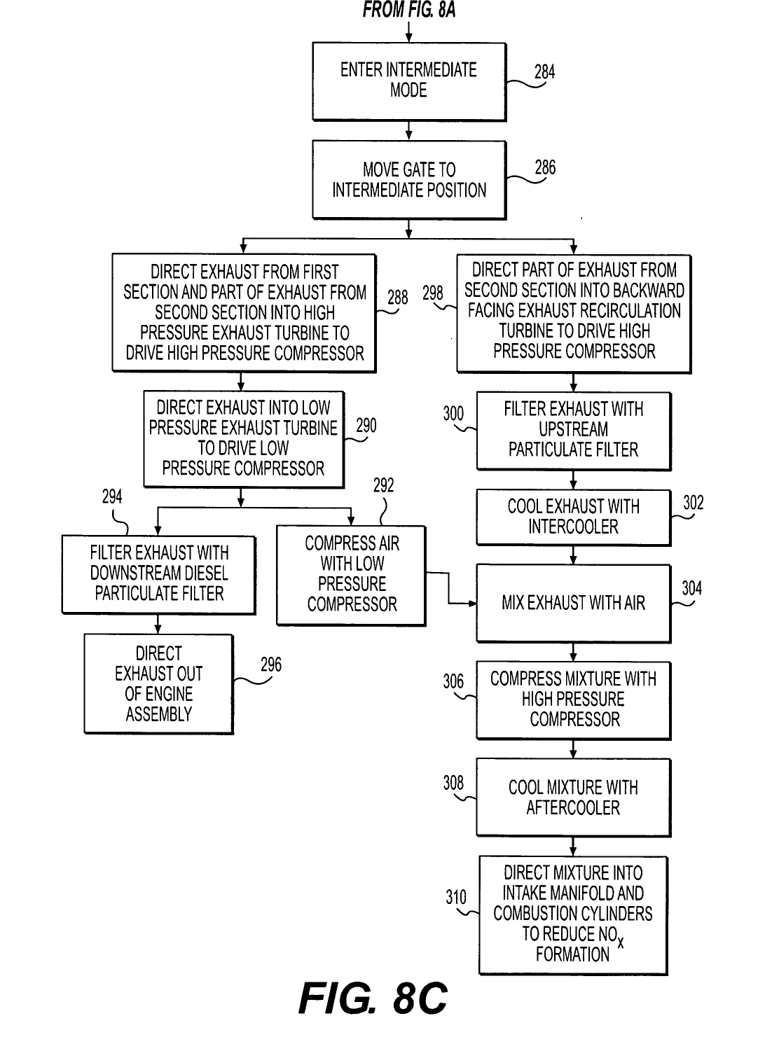

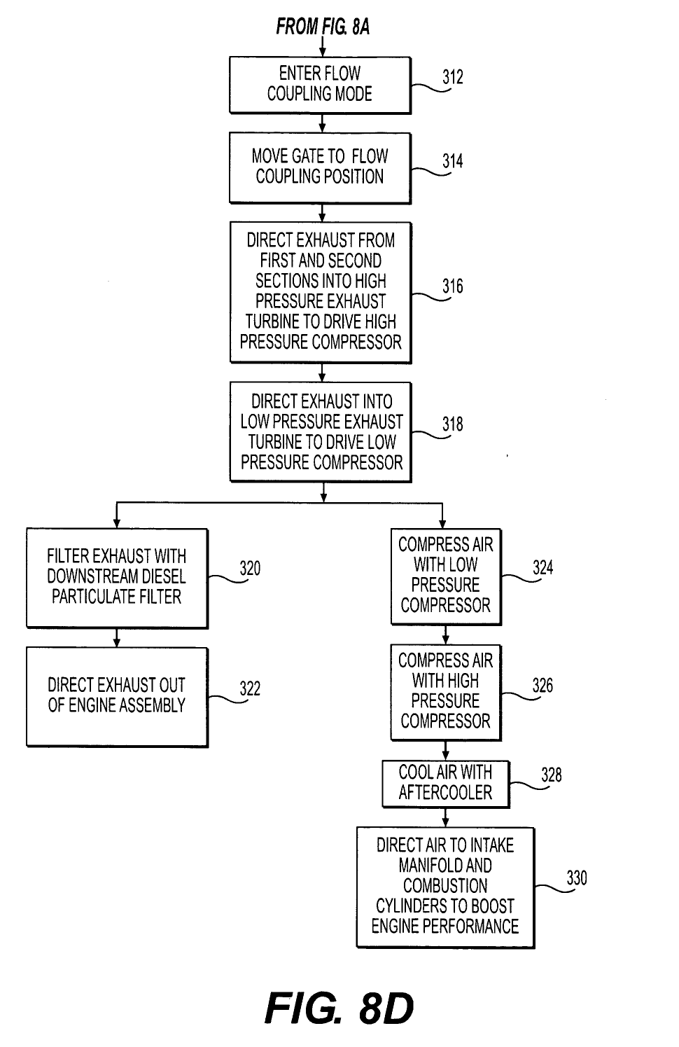

As shown in FIG. 8A, a method for exhaust recirculation may begin (step 240) with dividing combustion cylinders 14, 16, 18, 20, 22, and 24 into first and second cylinder groups 26 and 28 (step 242). First cylinder group 26 may be coupled to first section 40 of exhaust manifold 36 and second cylinder group 28 may be coupled to second section 42 of exhaust manifold 36 (step 244). A valve assembly 44 may be provided downstream from second section 42 (step 246). When fuel, air, and/or exhaust undergoes combustion in combustion cylinders 14, 16, 18, 20, 22, and 24 (step 248), the exhaust produced by combustion cylinders 14, 16, 18, 20, 22, and 24 may enter first and second sections 40 and 42 (step 250). The exhaust from second section 42 may be directed into valve assembly 44 (step 252). Electronic control module 58 may determine whether to place valve assembly 44 in an exhaust recirculation mode, an intermediate mode, or a flow coupling mode, based at least in part on the sensed engine conditions (step 254).

As shown in FIG. 8B, when valve assembly 44 is set in the exhaust recirculation mode (step 256), gate 70 may be moved to the flow isolating position (step 258) The exhaust from first section 40 may be directed into high pressure exhaust turbine 72 to drive high pressure compressor 74 (step 260). The exhaust may then be directed into low pressure exhaust turbine 94 to drive low pressure compressor 96 (step 262), which may compress air (step 264). The exhaust may be filtered using downstream diesel particulate filter 52 (step 266) before being directed out of engine assembly 10 (step 268). The exhaust from second section 42 may be directed into backward facing exhaust recirculation turbine 88 to drive high pressure compressor (step 270). The exhaust may be filtered (step 272), and then may be cooled with intercooler 54 (step 274). The exhaust may also be mixed with air compressed by low pressure compressor 96 to form a mixture having up to a fifty percent concentration of exhaust (step 276). The mixture may be compressed by high pressure compressor 74 (step 278). The mixture may then be cooled with aftercooler 56 (step 280). The mixture may enter intake manifold 32 and combustion cylinders 14, 16, 18, 20, 22, and 24 to reduce NOₓ formation in combustion cylinders 14, 16, 18, 20, 22, and 24 (step 282). It should be understood that at this point, the process may return to step 248.

As shown in FIG. 8C, when valve assembly 44 enters the intermediate mode (step 284), gate 70 may be moved to an intermediate position in between the flow isolating position and flow coupling positions (step 286). The exhaust from first section and part of the exhaust flow from second section 42 may be directed into high pressure exhaust turbine 72 to drive high pressure compressor 74 (step 288). The exhaust may be directed into low pressure exhaust turbine 94 to drive low pressure compressor 96 (step 290), which may compress air (step 292). Then, the exhaust may be filtered using downstream diesel particulate filter 52 (step 294) and directed out of engine assembly 10 (step 296). Another part of the exhaust flow from second section 42 may be directed into backward facing exhaust recirculation turbine 88 to help drive high pressure compressor 74 (step 298). The exhaust may be filtered by upstream particulate filter (step 300), cooled with intercooler 54 (step 302), and mixed with air compressed by low pressure compressor 96 (step 304). The mixture may be compressed by high pressure compressor 74 (step 306). The mixture may also be cooled by aftercooler 56 (step 308). The mixture may then be supplied to intake manifold 32 and combustion cylinders 14, 16, 18, 20, 22, and 24 to reduce the formation of NOₓ therein (step 310). Here, the process may return to step 248.

As shown in FIG. 8D, when valve assembly 44 enters the flow coupling mode (step 312), gate 70 may be moved to the flow coupling position (step 314). As such, all of the exhaust flow from first and second sections 40 and 42 may be directed into high pressure exhaust turbine 72 to drive high pressure compressor 74 (step 316). After exiting from high pressure exhaust turbine 72, the exhaust may be directed into low pressure exhaust turbine 94 to drive low pressure compressor 96 (step 318) prior to being filtered (step 320) and directed out of engine assembly 10 (step 322). Air compressed by low pressure compressor 96 (step 324) may be compressed by high pressure compressor 74 (step 326) and then cooled by aftercooler 56 (step 328). The air may then be supplied to intake manifold 32 and combustion cylinders 14, 16, 18, 20, 22, and 24 to help boost engine performance (step 330). Here the process may return to step 248.

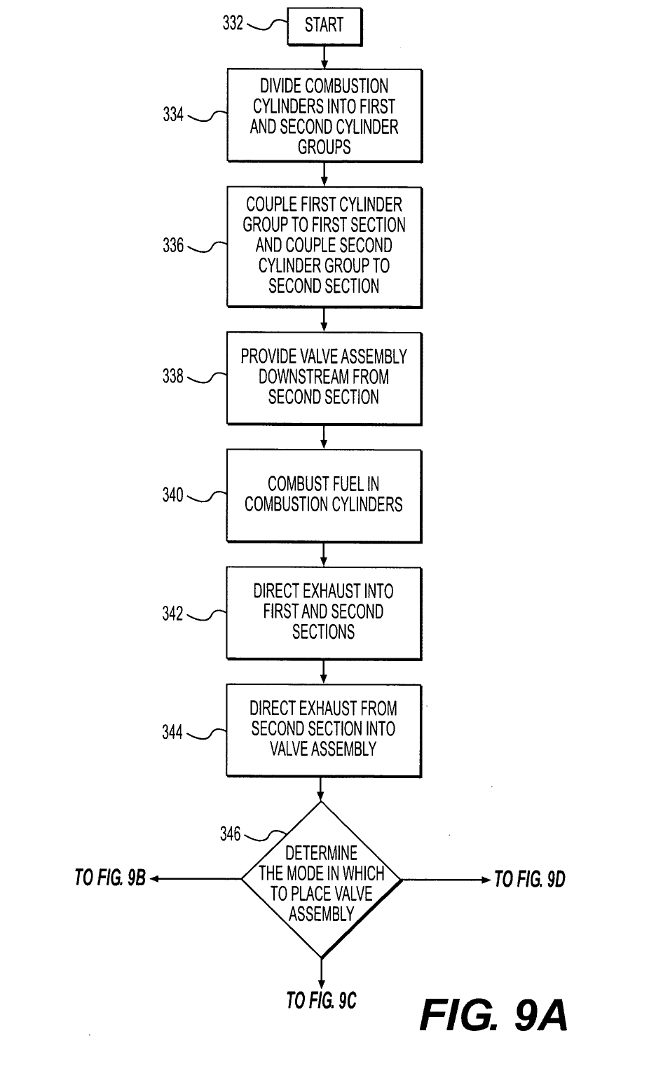

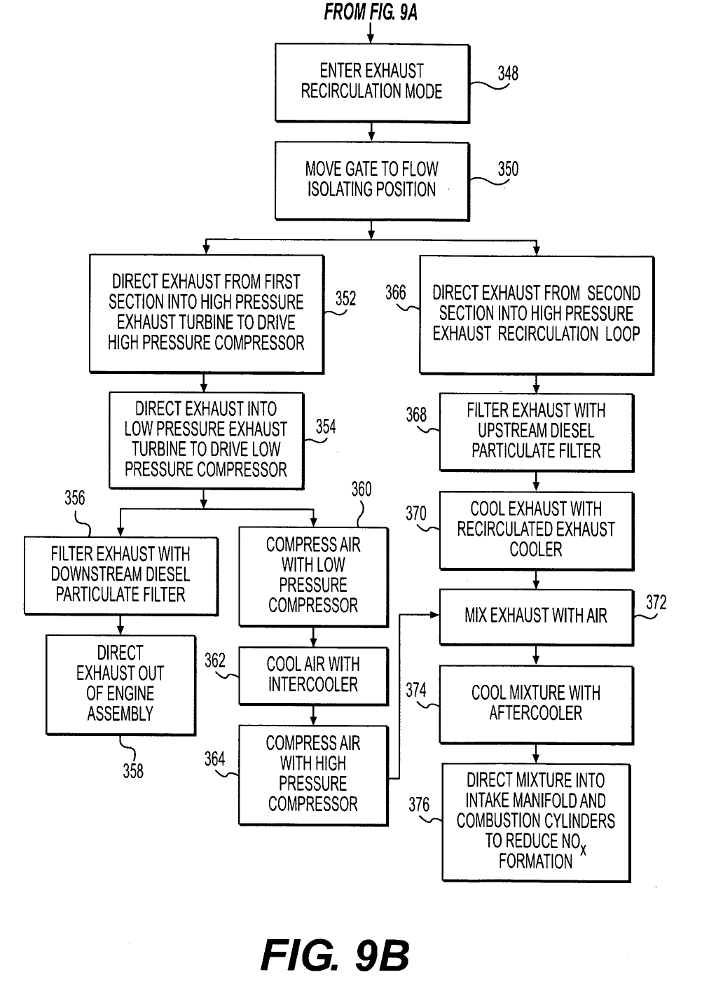

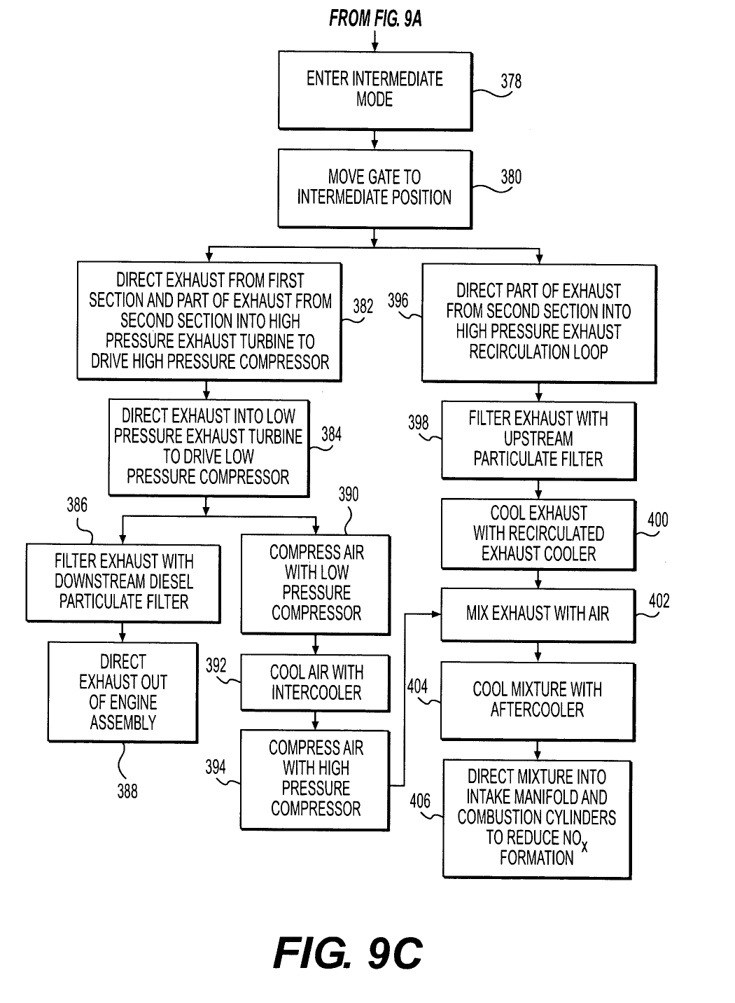

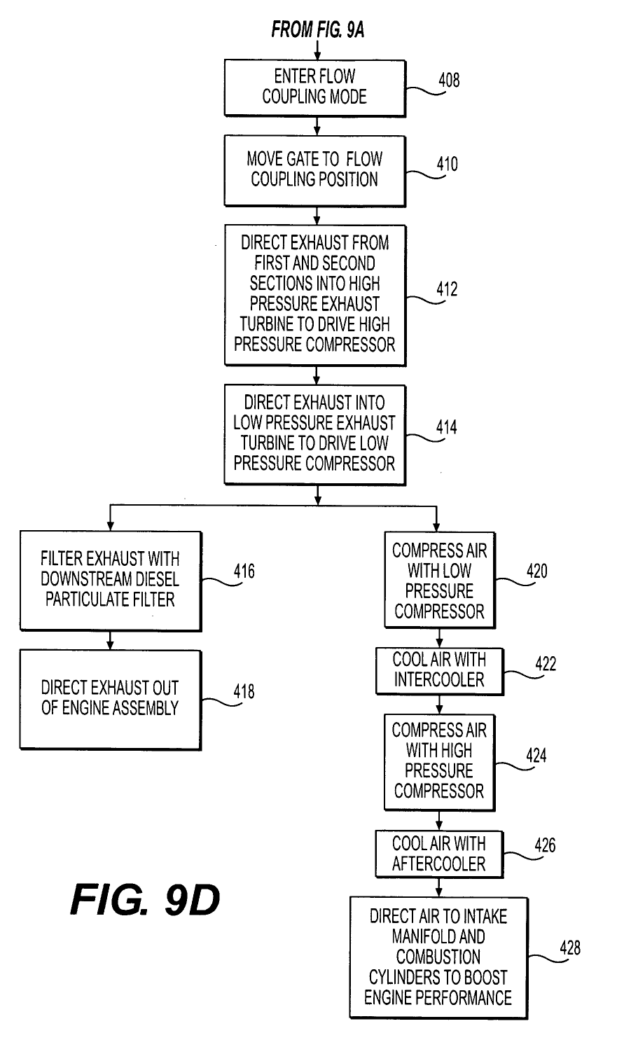

As shown in FIG. 9A, yet another method for exhaust recirculation may begin (step 332) with dividing combustion cylinders 14, 16, 18, 20, 22, and 24 into first and second cylinder groups 26 and 28 (step 334). First cylinder group 26 may be coupled to first section 40 of exhaust manifold 36 and second cylinder group 28 may be coupled to second section 42 of exhaust manifold 36 (step 336). A valve assembly 44 may be provided downstream from second section 42 (step 338). When fuel, air, and/or exhaust undergoes combustion in combustion cylinders 14, 16, 18, 20, 22, and 24 (step 340), the exhaust produced by combustion cylinders 14, 16, 18, 20, 22, and 24 may enter first and second sections 40 and 42 (step 342). The exhaust from second section 42 may be directed into valve assembly 44 (step 344). Electronic control module 58 may determine whether to place valve assembly 44 in an exhaust recirculation mode, an intermediate mode, or a flow coupling mode, based at least in part on the sensed engine conditions (step 346).

As shown in FIG. 9B, when valve assembly 44 enters the exhaust recirculation mode (step 348), gate 70 may be moved to the flow isolating position (step 350). The exhaust from first section 40 may be directed into high pressure exhaust turbine 72 to drive high pressure compressor 74 (step 352), and then into low pressure exhaust turbine 94 to drive low pressure compressor 96 (step 354). The exhaust may be filtered (step 356) and then directed out of engine assembly 10 (step 358). Low pressure compressor 96 may compress air (step 360) that may be cooled with intercooler 54 (step 362), and compressed again by high pressure compressor 74 (step 364). High pressure exhaust from second section 42 may be directed into high pressure exhaust recirculation loop 136 (step 366), filtered (step 368), cooled by recirculated exhaust cooler 138 (step 370), and then mixed with air (step 372). The mixture may be cooled by aftercooler 56 (step 374). The mixture may then be supplied to intake manifold 32 and combustion cylinders 14, 16, 18, 20, 22, and 24 to decrease the amount of NOₓ created within combustion cylinders 14, 16, 18, 20, 22, and 24 (step 376). Here, the process may return to step 340.

As shown in FIG. 9C, when valve assembly 44 enters the intermediate mode (step 378), gate 70 may be moved to an intermediate position between the flow isolating and flow coupling positions (step 380). The exhaust from first section 40 and part of the exhaust from second section 42 may be directed into high pressure exhaust turbine 72 to drive high pressure compressor 74 (step 382). Afterwards, the exhaust may be directed into low pressure exhaust turbine 94 to drive low pressure compressor 96 (step 384). The exhaust may be filtered (step 386) and then directed out of engine assembly 10 (step 388). Low pressure compressor 96 may compress air (step 390) that may be cooled with intercooler 54 (step 392), and compressed again by high pressure compressor 74 (step 394). Another part of the exhaust flow from second section 42 may be directed into high pressure exhaust recirculation loop 136 (step 396), filtered by upstream particulate filter (step 398), cooled with recirculated exhaust cooler 138 (step 400), and then mixed with air (step 402). The mixture may be cooled by aftercooler 56 (step 404). The cooled mixture may then be supplied to intake manifold 32 and combustion cylinders 14, 16, 18, 20, 22, and 24 to reduce NOₓ formation therein (step 406). Here, the process may return to step 340.

As shown in FIG. 9D, when valve assembly 44 enters the flow coupling mode (step 408), gate 70 may be moved to the flow coupling position (step 410). As such, all of the exhaust flow from first and second sections 26 and 28 may be directed into high pressure exhaust turbine 72 to drive high pressure compressor 74 (step 412). Afterwards, the exhaust may be directed into low pressure exhaust turbine 94 to drive low pressure compressor 96 (step 414). The exhaust may then be filtered (step 416) and directed out of engine assembly 10 (step 418). Air compressed by low pressure compressor 96 (step 420) may be cooled with intercooler 54 (step 422) prior to being compressed by high pressure compressor 74 (step 424). The air may also be cooled by aftercooler 56 (step 426). The cooled and compressed air may then be supplied to intake manifold 32 to help boost engine performance (step 428). Here, the process may return to step 340.

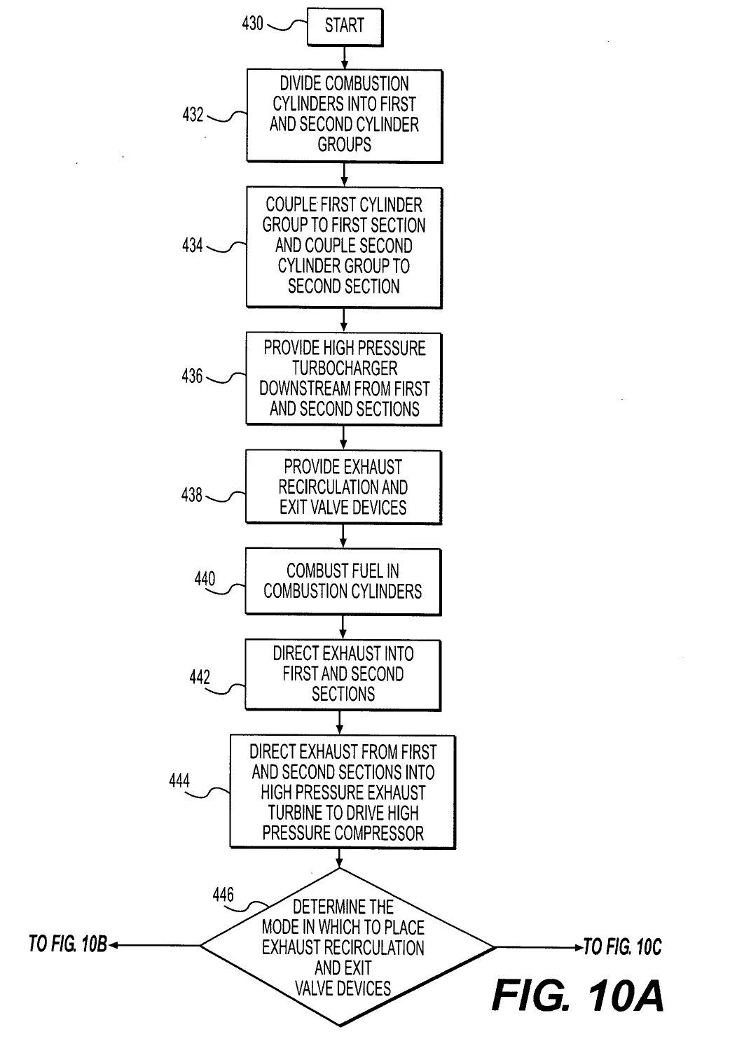

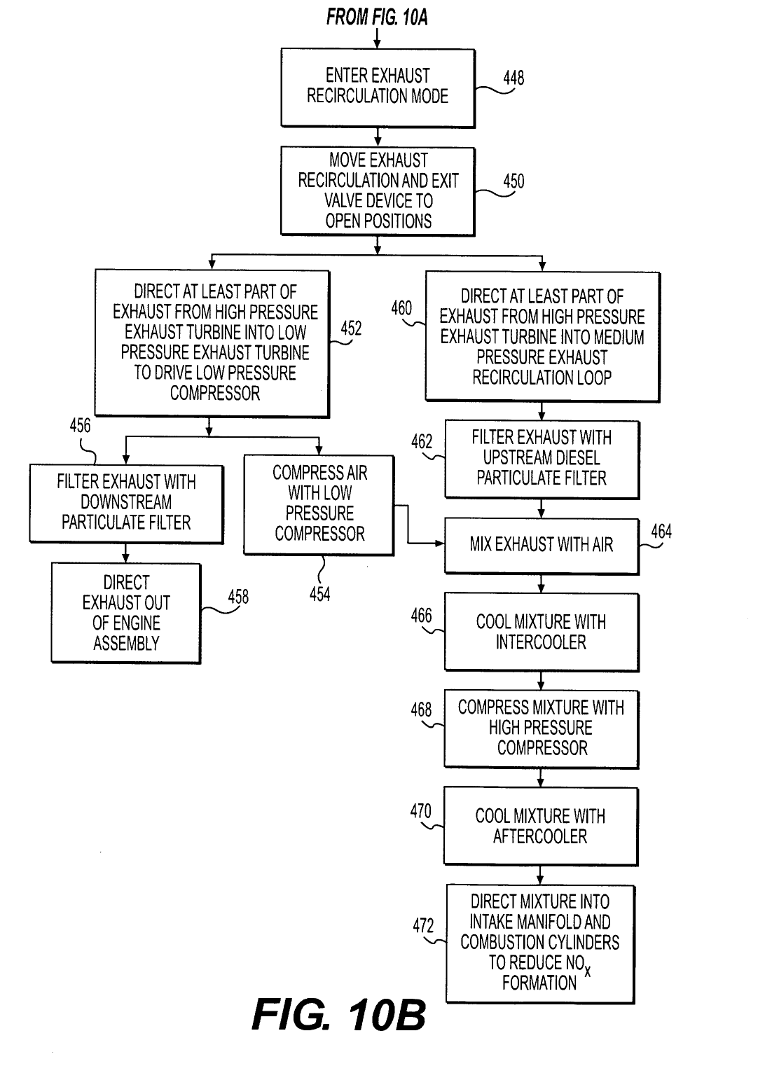

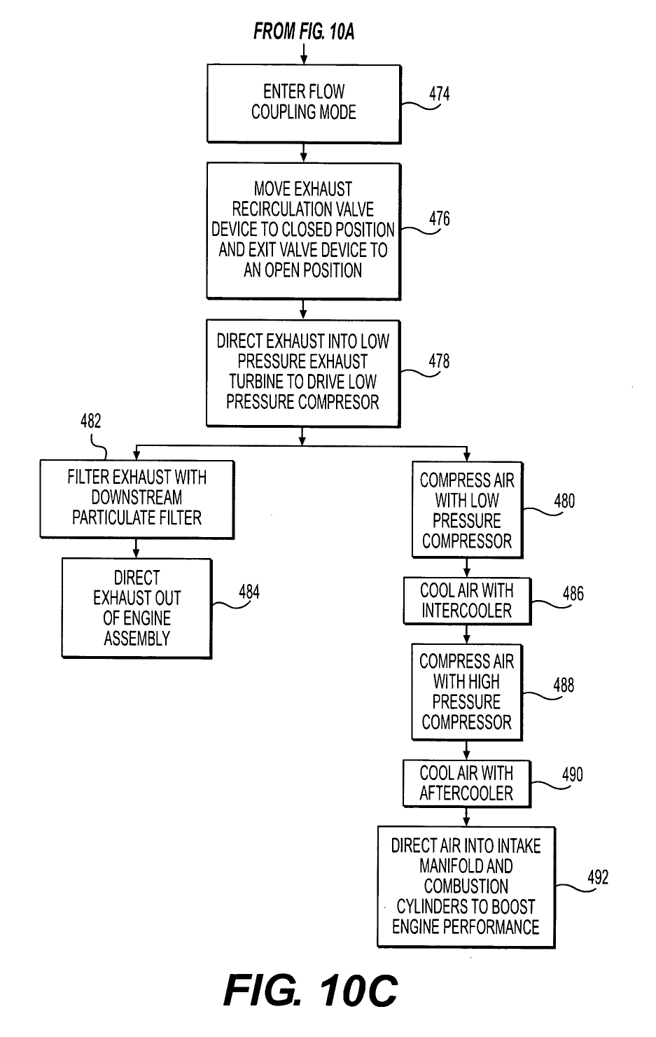

As shown in FIG. 10A, yet another method for exhaust recirculation may begin (step 430) with dividing combustion cylinders 14, 16, 18, 20, 22, and 24 into first and second cylinder groups 26 and 28 (step 432). First cylinder group 26 may be coupled to first section 40 of exhaust manifold 36 and second cylinder group 28 may be coupled to second section 42 of exhaust manifold 36 (step 434). High pressure turbocharger 46 may be provided downstream from first and second sections 40 and 42 (step 436). Exhaust recirculation and exit valve devices 142 and 144 may also be provided in exhaust assembly 38 (step 438). The combustion of fuel, air, and/or exhaust in combustion cylinders 14, 16, 18, 20, 22, and 24 (step 440) may cause exhaust to flow into first and second sections 40 and 42 (step 442). The exhaust from first and second sections 40 and 42 may be directed into high pressure exhaust turbine to drive high pressure compressor 74 (step 444). Electronic control module 58 may determine whether to place exhaust recirculation and exit valve devices 142 and 144 in an exhaust recirculation mode based at least in part on the sensed engine conditions (step 446).

As shown in FIG. 10B, when the exhaust recirculation mode is entered (step 448), exhaust recirculation and exit valve devices 142 and 144 may be moved to open positions (step 450). At least part of the exhaust from high pressure exhaust turbine 72 may be directed into low pressure exhaust turbine 94 to drive low pressure compressor 96 (step 452), which may compress air (step 454). The exhaust may be filtered by downstream diesel particulate filter 52 (step 456) prior to exiting from engine assembly 10 (step 458). Another part of the exhaust from high pressure exhaust turbine 72 may be directed into medium pressure exhaust recirculation loop 140 (step 460), where it may be filtered by upstream diesel particulate filter (step 462). The exhaust may be mixed with air compressed by low pressure compressor 96 to form a mixture (step 464). The mixture may be cooled by intercooler 54 (step 466) prior to being compressed with high pressure compressor 74 (step 468). The mixture may be cooled again by aftercooler 56 (step 470), and afterwards, the mixture may then be supplied to intake manifold 32 and combustion cylinders 14, 16, 18, 20, 22, and 24 to reduce NOₓ formation (step 472). Here the process may return to step 440.

As shown in FIG. 10C, when the flow coupling mode is entered (step 474), exhaust recirculation valve device 142 may be moved to a closed position while exit valve device 144 may be moved to an open position (step 476) to prevent at least some of the exhaust from entering medium pressure exhaust recirculation loop. As such, all of the exhaust flow from high pressure exhaust turbine 72 may be directed into low pressure exhaust turbine 94 to drive low pressure compressor 96 (step 478), which may compress air (step 480). The exhaust may be filtered by downstream diesel particulate filter 52 (step 482) prior to exiting from engine assembly 10 (step 484). Compressed air from low pressure compressor 96 may be cooled by intercooler 54 (step 486) prior to being compressed with high pressure compressor 74 (step 488). The air may be cooled by aftercooler 56 (step 490). The air may then be supplied to intake manifold 32 and combustion cylinders 14, 16, 18, 20, 22, and 24 to help boost engine performance (step 492). Here the process may return to step 440.

It is also contemplated that exhaust recirculation valve device 142 and/or exit valve device 144 may be moved into and out of and in between the open and closed positions by electronic control module 58. This may provide electronic control module 58 with greater control over the composition and quantity of intake gas entering intake manifold 32 and combustion cylinders 14, 16, 18, 20, 22, and 24.

### INDUSTRIAL APPLICABILITY

The disclosed system and method for exhaust recirculation may have applicability in engine assemblies. The system may have particular applicability in recirculating exhaust in an engine assembly 10.

An exhaust assembly 38 may be used to recirculate exhaust to an intake manifold 32 of an engine 12 to help reduce the oxygen concentration in combustion cylinders 14, 16, 18, 20, 22, and 24 of engine 12 and slow the chemical reaction of the combustion process to reduce NOₓ formation therein. Reducing the concentration of NOₓ in an exhaust stream may be one method of meeting stringent exhaust emissions standards set forth by the government.

Exhaust assembly 38 may recirculate exhaust from an exhaust manifold 36 of engine 12 to intake manifold 32 and to combustion cylinders 14, 16, 18, 20, 22, and 24. Exhaust assembly 38 may also control the ratio of exhaust to intake air to provide anywhere from zero percent recirculated exhaust to fifty percent recirculated exhaust, the exact ration being set by an electronic control module 58 to maintain a proper balance between engine performance and NOₓ reduction.

An intercooler 54 and/or an upstream diesel particulate filter 50 of an exhaust recirculation loop 68 may act like a restriction to the flow of exhaust. Thus, backpressure may develop in and along exhaust recirculation loop 68. Energy may be lost as engine 12 works to overcome the backpressure to force exhaust out from combustion chambers 14, 16, 18, 20, 22, and 24. This loss of energy may have negative effects on engine performance. Exhaust assembly 38 may limit the loss of energy by using a valve assembly 44 to isolate a first group 26 of combustion cylinders 14, 16, 18, 20, 22, and 24 from the backpressure in exhaust recirculation loop 68. Accordingly, the performance of first group 26 may not be penalized when exhaust is directed through exhaust recirculation loop. A second group 28 of combustion cylinders 14, 16, 18, 20, 22, and 24 may act as a pump to drive the recirculating exhaust through exhaust recirculation loop 68 and the rest of exhaust assembly 38. Thus, exhaust recirculation may be provided without detracting from the performance of at least half of combustion cylinders 14, 16, 18, 20, 22, and 24.

Exhaust assembly 38 may achieve exhaust recirculation using a reduced number of components. For example, an exhaust recirculation system having both a low pressure loop and a high pressure lobp may require multiple heat exchangers in each loop to cool the fluids flowing therein. Exhaust assembly 38 may only use a single loop for performing exhaust recirculation, and may require only an intercooler 54 and an aftercooler 56 to cool the recirculating exhaust and/or air. Reducing the number of heat exchangers may help to reduce the overall size and weight of engine assembly 10, and in doing so may also reduce manufacturing costs by cutting down on the amount of material being used to manufacture engine assembly 10.

Exhaust assembly 38 may also reduce turbocharger lag and improve engine response without requiring the use of variable geometry turbochargers. A variable geometry turbocharger may include movable vanes on its turbine to selectively present a greater turbine surface to allow the turbine to spool up more quickly. However, the movable vanes and other components in variable geometry turbochargers may be complex in terms of structure and operation, and thus, may be more costly to manufacture or maintain than other types of turbochargers. Even without the use of movable vanes, a high pressure turbocharger 46 of exhaust assembly 38 may spool up quickly because valve assembly 44 may selectively direct the full flow of exhaust from combustion cylinders 14, 16, 18, 20, 22, and 24 towards a high pressure exhaust turbine 72 of high pressure turbocharger 46. Thus, the advantages of using a variable geometry turbocharger may be achieved using less complex and less costly turbochargers.

Furthermore, providing an exhaust recirculation turbine 88 to handle a share of the total exhaust flow from combustion cylinders 14, 16, 18, 20, 22, and 24 may allow use of a smaller high pressure exhaust turbine 72. Reducing the size of high pressure exhaust turbine 72 may also provide performance advantages. For example, a turbine may require a certain amount of exhaust flow to reach a desired speed in a set period of time. By reducing the size the that turbine, it may be capable of reaching that desired speed in a shorter period of time, possibly even with a lesser amount of exhaust flow. Thus, reducing the size of high pressure exhaust turbine 72 may decrease the spooling time of high pressure turbocharger 46, and thus, may improve engine response.

Intake manifolds of engines tend to have high boost pressures. Recirculating exhaust may flow better when it does not have to work to overcome those high boost pressures. Thus, exhaust assembly 38 may be configured to introduce the exhaust flow into an intake gas loop 86 of engine 12 at a location in exhaust assembly 38 having a lower pressure than the boost pressure at intake manifold 32. As fluids generally flow more easily towards low pressures than high pressures, the recirculating exhaust may travel more readily to the location with the lower pressure than to intake manifold 32.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. An engine assembly, comprising:
an engine having a plurality of combustion cylinders;
an exhaust manifold configured to receive exhaust from the plurality of combustion cylinders, wherein the exhaust manifold is divided into first and second sections, the first section being fluidly coupled to a first group of combustion cylinders, and the second section being fluidly coupled to a second group of combustion cylinders;
a turbocharger having an exhaust turbine configured to receive exhaust from the first section; and
a proportional valve assembly configured to selectively fluidly couple the second section to at least one of the turbocharger and an exhaust recirculation loop.

2. The engine assembly of claim 1, wherein the exhaust recirculation loop includes an exhaust recirculation turbine configured to recover energy from exhaust flowing through the exhaust recirculation loop.

3. The engine assembly of claim 2, wherein the turbocharger includes a shaft, and the exhaust turbine and exhaust recirculation turbine are mounted on the shaft.

4. The engine assembly of claim 3, wherein the exhaust turbine and the exhaust recirculation turbine are oriented to face opposite directions.

5. The engine assembly of claim 1, wherein the exhaust recirculation loop is fluidly coupled to an intake gas loop, and exhaust in the exhaust recirculation loop enters the intake gas loop at a location having a lower pressure than that of an intake manifold of the engine.

6. The engine assembly of claim 1, wherein the proportional valve assembly is configured to isolate the first group from backpressure in the exhaust recirculation loop.

7. A machine comprising:
an engine assembly including an engine having an intake manifold and a plurality of combustion cylinders fluidly coupled to the intake manifold;
an exhaust assembly including:
an exhaust manifold divided into first and second sections, the first section being fluidly coupled to a first half of the combustion cylinders, and the second section being fluidly coupled to a second half of the combustion cylinders,
a turbocharger assembly downstream from the exhaust manifold,
a proportional valve assembly between the exhaust manifold and the turbocharger assembly, the proportional valve assembly being configured to selectively fluidly couple the second section to at least one of an exhaust loop and an exhaust recirculation loop of the exhaust assembly; and
an intake gas loop fluidly coupled to the exhaust recirculation loop and the intake manifold.

8. The machine of claim 7, wherein the exhaust loop includes an exhaust turbine fluidly coupled to the proportional valve assembly, the exhaust turbine being configured to drive a first compressor.

9. The machine of claim 8, wherein the exhaust recirculation loop includes an exhaust recirculation turbine fluidly coupled to the proportional valve assembly, the exhaust recirculation turbine being configured to drive the first compressor, and wherein the exhaust turbine and exhaust recirculation turbine are mounted on a common shaft.

10. The machine of claim 9, wherein the exhaust recirculation turbine and the exhaust turbine face in opposite directions.

11. The machine of claim 7, wherein the proportional valve assembly includes a gate, the gate being configured to isolate the first half from backpressure in the exhaust recirculation loop when the gate is moved into a flow isolating position, and being configured to fluidly couple the first and second halves when the gate is moved into a flow coupling position.

12. The machine of claim 7, wherein the intake gas loop and the exhaust recirculation loop meet at a junction located upstream from the intake manifold.

13. A method of managing intake gas in an engine assembly, the method comprising:
dividing a plurality of combustion cylinders into first and second cylinder groups;
fluidly coupling the first cylinder group to a first section of an exhaust manifold and fluidly coupling the second cylinder group to a second section of the exhaust manifold;
providing a proportional valve assembly downstream from the second section;
combusting fuel in the combustion cylinders, wherein combustion produces exhaust;
directing the exhaust into the first and second sections;
directing the exhaust from the second section into the proportional valve assembly; and
using an electronic control module to sense engine conditions and adjust the proportional valve assembly based at least in part on the sensed engine conditions.

14. The method of claim 13, wherein adjusting the proportional valve assembly includes placing the proportional valve assembly in a recirculation mode by moving a gate of the proportional valve assembly into a flow isolating position to direct exhaust from the second section into an exhaust recirculation loop, the gate isolating the first section from backpressure in the exhaust recirculation loop.

15. The method of claim 14, further including mixing the exhaust in the exhaust recirculation loop with air, and directing the mixture into an intake manifold of an engine.

16. The method of claim 14, further including directing exhaust from the second section into an exhaust recirculation turbine of a turbocharger.

17. The method of claim 16, further including recovering energy by using exhaust recirculation turbine to help drive a compressor.

18. The method of claim 17, wherein the exhaust turbine and the exhaust recirculation turbine are mounted on a common shaft of the turbocharger.

19. The method of claim 13, wherein adjusting the proportional valve assembly may include placing the proportional valve assembly in a flow coupling mode by moving a gate of the proportional valve assembly into a flow coupling position to direct exhaust from the first and second sections into the exhaust turbine.

20. The method of claim 13, wherein adjusting the proportional valve assembly may include placing the proportional valve assembly in an intermediate mode by moving a gate of the proportional valve assembly into an intermediate position to direct a first portion of exhaust from the second section into the exhaust recirculation loop, and a second portion of exhaust from the second section into the exhaust turbine.
